(19) United States
(12) Patent Application Publication
(10) Pub. No.: US 2026/0189701 A1
(43) Pub. Date: Jul. 2, 2026

(54) FILTERING METHOD AND APPARATUS FOR AV1, COMPUTER DEVICE AND STORAGE MEDIUM

(71) Applicant: SHANGHAI BILIBILI TECHNOLOGY CO., LTD., Shanghai (CN)

(72) Inventors: Xiaobo LI, Shanghai (CN); Chunlei CAI, Shanghai (CN); Tianxiao YE, Shanghai (CN)

(21) Appl. No.: 19/127,666

(22) PCT Filed: Jul. 6, 2023
(86) PCT No.: PCT/CN2023/106147

§ 371 Date: May 6, 2025

(30) Foreign Application Priority Data
Nov. 11, 2022 (CN) 202211417263.3

(51) Int. Cl. H04N 19/117; H04N 19/119; H04N 19/176; H04N 19/436; H04N 19/82

(52) U.S. Cl. CPC H04N 19/117; H04N 19/119; H04N 19/176; H04N 19/436; H04N 19/82

(57) ABSTRACT

The application discloses a filtering method for AV1, including: determining a to-be-filtered partition, wherein the to-be-filtered partition includes a plurality of blocks, and the plurality of blocks form a plurality of rows; and performing parallel filtering operations on at least two of the plurality of blocks by using several threads, wherein the several threads are responsible for filtering operations on several rows in a one-to-one correspondence, the several rows include at least two consecutive rows in the plurality of rows, and each block in the at least two blocks is respectively located in a different row. The application further discloses a filtering apparatus, a computer device, and a computer-readable storage medium.

The application claims priority to Chinese Patent Application No. 202211417263.3, filed on Nov. 11, 2022, and entitled “FILTERING METHOD AND APPARATUS FOR AV1”, which is incorporated herein by reference in its entirety.

### TECHNICAL FIELD

The application relates to the video coding field, and in particular, to a filtering method and apparatus for AV1, a computer device, and a computer-readable storage medium.

### BACKGROUND

AOMedia Video 1 (AV1) is an open video codec format designed for real-time network transmission. AV1 is a subsequent product of VP9 developed by the Alliance for Open Media (AOMedia). Many components of the AV1 project are derived from previous research work of alliance members. Individual contributors initiated experimental technology platforms at an early stage: Xiph/Mozilla's Daala released code in 2010, Google's experimental successor VP10 to VP9 was released on Sep. 12, 2014, and Cisco's Thor was released on Aug. 11, 2015. AV1 is based on a code library of VP9, and incorporates other technologies, some of which are developed in these experimental formats. The first version 0.1.0 of an AV1 reference codec was released on Apr. 7, 2016. The alliance announced the release of the AV1 bitstream specification as well as a software-based reference encoder and decoder on Mar. 28, 2018. The alliance released a validated version 1.0.0 of the specification on Jun. 25, 2018. The alliance released a validated version 1.0.0 with errata 1 on Jan. 8, 2019. The AV1 bitstream specification includes a reference video codec. As an AV1 encoder is optimized, AV1 can achieve higher compression efficiency than VP9 and H.264.

An encoding process for AV1 usually includes operations such as block partitioning, prediction (inter prediction and intra prediction), data transformation, quantization, entropy coding, and filtering. The inventors are aware that a current filtering manner restricts an improvement in encoding efficiency to some extent.

### SUMMARY

An objective of embodiments of the application is to provide a filtering method and apparatus for AV1, a computer device, and a computer-readable storage medium, to resolve the foregoing problem.

An aspect of the embodiments of the application provides a filtering method for AV1, including:
determining a to-be-filtered partition, wherein the to-be-filtered partition includes a plurality of blocks, and the plurality of blocks form a plurality of rows; and
performing parallel filtering operations on at least two of the plurality of blocks by using several threads, wherein the several threads are responsible for filtering operations on several rows in a one-to-one correspondence, the several rows include at least two consecutive rows in the plurality of rows, and each block in the at least two blocks are respectively located in a different row.

Optionally, the several rows include a first row and one or more subsequent rows following the first row; and the performing parallel filtering operations on at least two of the plurality of blocks includes:
performing the following filtering operation on the first row: sequentially filtering each block in the first row from left to right; and
performing the following filtering operation on the one or more subsequent rows: sequentially filtering each block in a target row from left to right, wherein a filtering progress of the target row lags behind a filtering progress of a previous row of the target row by a filtering time of two blocks, and the target row is any one of the one or more subsequent rows.

Optionally, the several rows include an m^{th} row and one or more subsequent rows following the m^{th} row, and m is an integer greater than or equal to 2; and the performing parallel filtering operations on at least two of the plurality of blocks includes:
sequentially filtering each block in a target row from left to right by using a thread allocated to the target row, wherein
a filtering progress of the target row lags behind a filtering progress of a previous row of the target row by a filtering time of two blocks, and the target row is the m^{th} row or any one of the one or more subsequent rows.

Optionally, the target row corresponds to an nth row, and n is an integer greater than or equal to 2; and the performing parallel filtering operations on at least two of the plurality of blocks includes:
recording a quantity of filtered blocks in each row, wherein the quantity of filtered blocks indicates a quantity of currently filtered blocks;
filtering a currently unfiltered block in the nth row when a quantity of filtered blocks in an (n−1)^{th} row is greater than a maximum preset value, wherein the maximum preset value is a total quantity of blocks in the (n−1)^{th} row; and
filtering a corresponding block in the nth row when the quantity of filtered blocks is greater than 2 and is less than or equal to the maximum preset value, wherein a location of the corresponding block in the n^{th} row is the quantity of filtered blocks minus 2.

Optionally, the method further includes:
configuring a thread for the (n−1)^{th} row to perform a filtering operation on an (n+N−1)^{th} row when the quantity of filtered blocks in the (n−1)^{th} row is greater than the maximum preset value, wherein N is a positive integer, and is used to indicate a total quantity of the several threads.

An aspect of the embodiments of the application provides a filtering apparatus for AV1, including:
a determining module, configured to determine a to-be-filtered partition, wherein the to-be-filtered partition includes a plurality of blocks, and the plurality of blocks form a plurality of rows; and
a filtering module, configured to perform parallel filtering operations on at least two of the plurality of blocks by using several threads, wherein the several threads are responsible for filtering operations on several rows in a one-to-one correspondence, the several rows include at least two consecutive rows in the plurality of rows, and each block in the at least two blocks is respectively located in a different row.

Optionally, the filtering module is further configured to:
record a quantity of filtered blocks in each row, wherein the quantity of filtered blocks indicates a quantity of currently filtered blocks;
filter a currently unfiltered block in an n^{th} row when a quantity of filtered blocks in an (n−1)^{th} row is greater than a maximum preset value, wherein the maximum preset value is a total quantity of blocks in the (n−1)^{th} row, and n is an integer greater than or equal to 2; and
filter a corresponding block in the n^{th} row when the quantity of filtered blocks is greater than 2 and is less than or equal to the maximum preset value, wherein a location of the corresponding block in the n^{th} row is the quantity of filtered blocks minus 2.

Optionally, the apparatus further includes a configuration module, configured to:
configure a thread for the (n−1)^{th} row to perform a filtering operation on an (n+N−1)^{th} row when the quantity of filtered blocks in the (n−1)^{th} row is greater than the maximum preset value, wherein N is a positive integer, and is used to indicate a total quantity of the several threads.

An aspect of the embodiments of the application further provides a computer device, including a memory, a processor, and computer-readable instructions that are stored in the memory and that are capable of running on the processor, wherein when executing the computer-readable instructions, the processor is configured to implement the following steps:
determining a to-be-filtered partition, wherein the to-be-filtered partition includes a plurality of blocks, and the plurality of blocks form a plurality of rows; and
performing parallel filtering operations on at least two of the plurality of blocks by using several threads, wherein the several threads are responsible for filtering operations on several rows in a one-to-one correspondence, the several rows include at least two consecutive rows in the plurality of rows, and each block in the at least two blocks is respectively located in a different row.

An aspect of the embodiments of the application further provides a computer-readable storage medium, storing computer-readable instructions, wherein the computer-readable instructions are capable of being executed by at least one processor to enable the at least one processor to perform the following steps:
determining a to-be-filtered partition, wherein the to-be-filtered partition includes a plurality of blocks, and the plurality of blocks form a plurality of rows; and
performing parallel filtering operations on at least two of the plurality of blocks by using several threads, wherein the several threads are responsible for filtering operations on several rows in a one-to-one correspondence, the several rows include at least two consecutive rows in the plurality of rows, and each block in the at least two blocks is respectively located in a different row.

The filtering method and apparatus for AV1, the computer device, and the computer-readable storage medium provided in the embodiments of the application include the following advantages:

Compared with a single-threaded block-by-block filtering manner, the embodiments use several threads, so that parallel filtering operations can be performed on different blocks by using two or more threads on the premise that a filtering rule is met, thereby improving efficiency.

### BRIEF DESCRIPTION OF DRAWINGS

FIG. 1 schematically shows a conventional filtering manner for AV1;

FIG. 2 schematically shows a diagram of an application environment of a filtering method for AV1 according to an embodiment of the application;

FIG. 3 schematically shows a flowchart of a filtering method for AV1 according to Embodiment 1 of the application;

FIG. 4 schematically shows a partition including a plurality of blocks;

FIG. 5 schematically shows filtering orders of a plurality of blocks;

FIG. 6 schematically shows coordinates of a plurality of blocks;

FIG. 7 schematically shows an operation procedure of a filtering method for AV1 in an example application according to Embodiment 1 of the application;

FIG. 8 schematically shows a block diagram of a filtering apparatus for AV1 according to Embodiment 2 of the application; and

FIG. 9 schematically shows a schematic diagram of a hardware architecture of a computer device suitable for implementing a filtering method for AV1 according to Embodiment 3 of the application.

### DESCRIPTION OF EMBODIMENTS

To make the objectives, technical solutions, and advantages of the application clearer and more comprehensible, the following further describes the application in detail with reference to the accompanying drawings and the embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

In the descriptions of the application, it should be understood that numerical symbols before steps do not indicate a sequence of performing the steps, but are merely used to facilitate description of the application and differentiation of each step, and therefore cannot be construed as a limitation on the application.

The following provides an explanation of the terms in the application:

AOMedia Video 1 (AV1) is an open source and royalty-free video codec developed by the Alliance for Open Media (AOMedia). Based on a use situation, AV1 can achieve higher compression efficiency than VP9 and H.264.

To help a person skilled in the art understand the technical solutions provided in the embodiments of the application, the following describes related technologies.

An encoding process for AV1 includes the following processes: block partitioning, prediction, transformation, quantization, entropy coding, filtering, post-processing, and the like.

### (1) Block Partitioning:

An image (frame) may be partitioned into interleaved, adjacent, and equal-sized coding units (for example, a superblock of 128×128 pixels), and then the image may be processed in units of the coding units. The superblock may be partitioned into smaller blocks based on different partitioning modes. For example, the superblock may be partitioned into a plurality of blocks of 4×4 pixels. The partitioning mode may be a four-equal-part split (SPLIT) or a two-equal-part split (HORZ or VERT).

### (2) Prediction:

A current pixel is predicted based on a correlation between image pixels by using a neighboring pixel. For example, a difference of each image is obtained based on a key frame by using intra prediction and inter prediction, so that a quantity of pieces of stored encoded information is reduced. Intra prediction is used to remove intra-frame spatial redundancy, to obtain a residual unit whose pixel value is less than that of the coding unit. Inter prediction is used to remove inter-frame time redundancy, to obtain a residual unit whose pixel value is less than that of the coding unit.

Intra prediction may predict a pixel of a target block based on available information in a current frame. In most cases, intra prediction is constructed from neighboring pixels above and on the left side of a to-be-predicted target block.

### (3) Data Transformation:

Low-frequency information and high-frequency information are separated through a discrete cosine transform (DCT), to transform the residual unit into a “transform unit (TU)”. It should be noted that other transformation manners may alternatively be used.

### (4) Quantization:

A transform coefficient in the TU is quantized based on a quantization step, to obtain a quantization level, and unimportant data is reset to zero, to reduce a data amount.

### (5) Entropy Coding:

Entropy coding is a type of encoding in which no information is lost according to an entropy principle. For example, continuous repeated data is represented by a quantity of repetition times.

(6) Filtering and Post-Processing: A Block Artifact, Noise, and the Like can be Eliminated by Using a Filtering Operation, which May be Implemented by Using Various Filters.

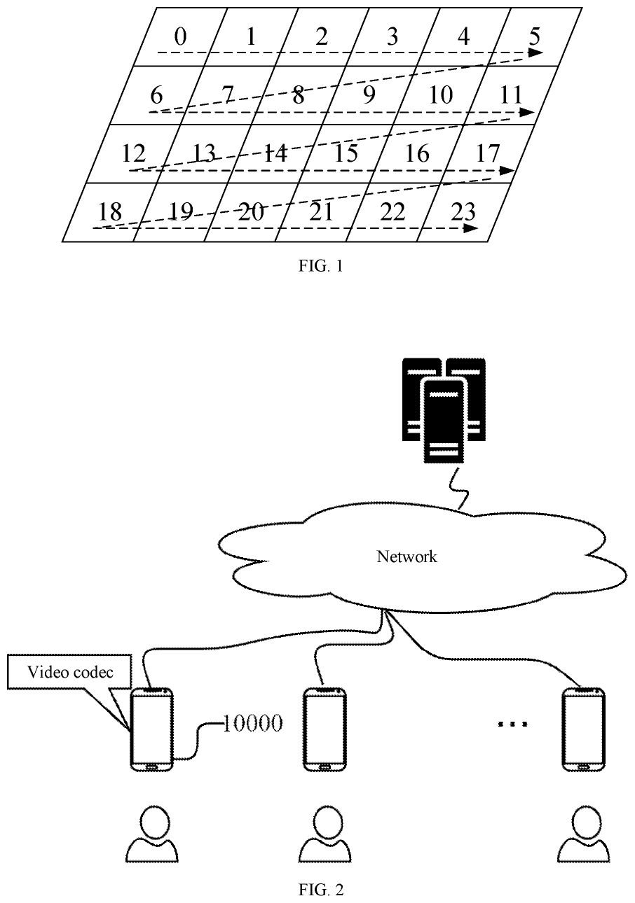

The inventors have realized that a current filtering manner for AV1 is to sequentially filter each block from left to right and from top to bottom based on coordinates of the block. As shown in FIG. 1, processing is performed row by row in a unit of each block (block 0 to block 5 are first processed one by one, then block 6 to block 11 are processed one by one, and the like). If a block 12 is to be processed, it needs to wait for all preceding blocks 0-11 to be completely processed. It can be learned that a later block needs to wait for a longer time and has low encoding efficiency.

In view of this, the application is intended to provide a filtering solution for AV1. In the solution, a parallel filtering manner is provided, to resolve problems of a long waiting time and low encoding efficiency caused by the foregoing row-by-row filtering. For example, a plurality of threads may be enabled. It is assumed that there are N (a positive integer greater than 2) threads, and each thread is responsible for a filtering operation on one row. Filtering may alternatively be performed in a manner in which filtering on each row lags behind filtering on a previous row by two blocks. When a filtering operation starts to be performed on a (b+2)^{th} block in an n^{th} row, filtering starts to be performed on a b^{th} block in an (n+1)^{th} row. For details, refer to the following descriptions.

The following provides an example application environment of the application. For example, the application may be applied to a computer device 10000 shown in FIG. 1.

The computer device 10000 may be configured to access content (for example, a video) and a service of a server.

The computer device 10000 may include an electronic device that carries or is connected to a display panel, for example, a mobile device, a tablet device, a laptop computer, a workstation, a virtual reality device, a game device, a digital streaming device, a vehicle user terminal, a smart television, or a set-top box, or may include a virtualized computing instance. The virtualized computing instance may include a simulation of a virtual machine such as a computer system, an operating system, or a server.

The computer device 10000 may be associated with one or more client computing devices. A single client computing device may also access the server by using one or more computer devices 10000. The computer device 10000 may travel to various locations and use different networks to access the server. The computer device 10000 may include a plurality of client programs such as a video codec, configured to provide an encoding service and a decoding service. The video codec may perform encoding and compression on a video or an image, to help transmit or store the video or the image.

The following provides a plurality of embodiments in the foregoing example application environment, to describe the filtering solution for AV1.

### Embodiment 1

It should be noted that the embodiment may be executed by a computer device 10000.

A filtering operation described in the embodiment can improve output quality and improve visual experience. The filtering operation may be implemented by using a filter. The filter may be normative or non-normative. A normative filter is an essential part of a codec, and if the normative filter is missing, a video cannot be correctly decoded. The non-normative filter is optional.

Filters may be classified based on an application location, for example, a preprocessing filter applied to an input before encoding starts, a post-processing filter applied to an output after decoding is completed, and a loop filter used as an integrated part of encoding processing in an encoding cycle. The preprocessing and post-processing filters are usually non-normative, and are located outside the codec. By definition, the loop filter should be normative, and is a part of the codec. The loop filter is used in an encoding optimization process, and is applied to a stored reference frame or inter coding.

The filtering operation described in the embodiment may be applied to a loop filtering module and a post-processing module.

A block artifact, noise, and the like can be eliminated by using the filtering operation. For example, a filter that may be used includes but is not limited to a de-blocking filter, a constrained directional enhancement filter, and a loop recovery filter.

The de-blocking filter performs filtering at a 128×128 superblock level, and separately filters a vertical edge and a horizontal edge. For a superblock of 128×128 pixels, a vertical/horizontal edge aligned with each 8×8 block is first filtered. If transformation of 4×4 pixels is used, an internal edge aligned with a block of 4×4 pixels is further filtered.

The constrained directional enhancement filter eliminates or reduces basic noise and a ringing effect near a hard edge of an image without blurring or damaging the edge. Edge direction search is performed at an 8×8 block level. There are eight edge directions in total.

The loop recovery filter may include a separable symmetric Wiener filter, a dual self-guided filter, and the like. The loop recovery filter can remove fuzzy ringing caused by block processing. The ringing effect is one of factors that affect quality of a restored image, and is caused by an improper image model selected in image restoration. A reason for the ringing effect includes loss of an information amount (for example, high-frequency information) in an image degradation process, which seriously reduces quality of the restored image and makes it difficult to perform subsequent processing on the restored image.

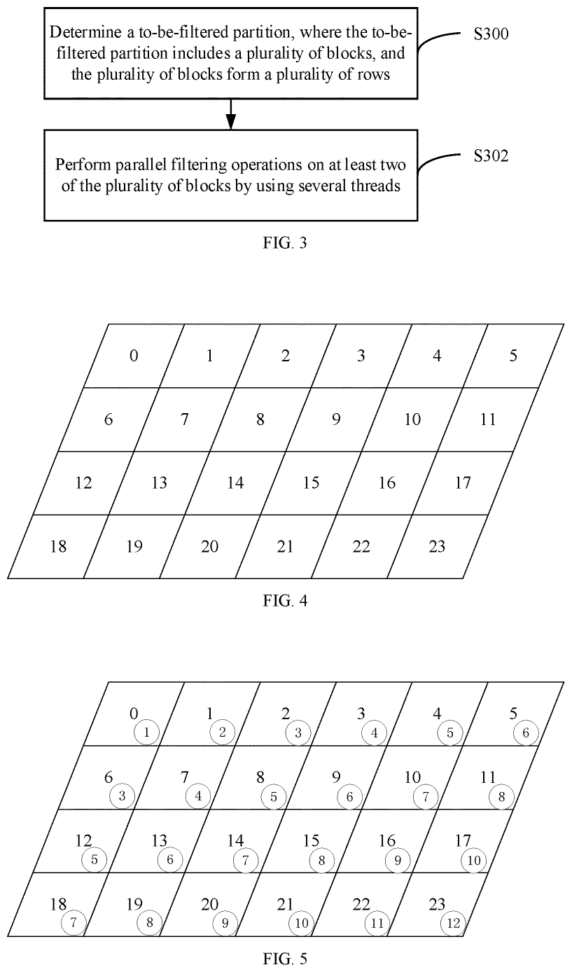

FIG. 3 schematically shows a flowchart of a filtering method for AV1 according to Embodiment 1 of the application.

As shown in FIG. 3, the filtering method for AV1 may include steps S300 to S302.

Step S300: Determine a to-be-filtered partition, wherein the to-be-filtered partition includes a plurality of blocks, and the plurality of blocks form a plurality of rows.

A to-be-encoded frame (the to-be-filtered partition) may be partitioned into a plurality of superblocks (128×128 pixels). Each superblock is further partitioned into smaller blocks. In a filtering operation, each block may be filtered in units of these blocks according to a specific rule.

In the embodiment, the plurality of blocks obtained by partitioning the to-be-filtered partition are arranged in rows and columns, in other words, a plurality of rows is formed. The to-be-filtered partition shown in FIG. 4 includes 24 blocks: a block 0 to a block 23. The block 0 to a block 5 form a first row, a block 6 to a block 11 form a second row, a block 12 to a block 17 form a third row, and a block 18 to the block 23 form a fourth row.

Step S302: Perform parallel filtering operations on at least two of the plurality of blocks by using several threads. The several threads are responsible for filtering operations on several rows in a one-to-one correspondence, the several rows include at least two consecutive rows in the plurality of rows, and each block in the at least two blocks is respectively located in a different row.

Blocks at an upper edge may be directly filtered from left to right one by one based on a filtering direction and rule of a filter. A block at a left edge may be filtered when filtering of a block directly above the block is completed. A block located outside the upper edge and the left edge may be filtered when both filtering of a block directly above the block and filtering of a block directly on the left side of the block are completed.

The following provides descriptions by using an example with reference to FIG. 4. Theoretically,
when filtering of the block 0 is completed by using a thread #1, the block 1 is filtered next. In the case, filtering of the block 0 directly above the block 6 is completed. Therefore, the block 6 may also be filtered in the case. Therefore, in the case, the block 1 may be filtered by using the thread #1, and the block 6 may be filtered by using a thread #2, thereby implementing parallel filtering on the block 1 and the block 6.

When filtering of the blocks 0 and 1 is completed by using the thread #1 and filtering of the block 6 is completed by using the thread #2, a block 2 is filtered next by using the thread #1. In the case, filtering of the block 1 directly above a block 7 is completed, and filtering of the block 6 directly on the left side of the block 7 is completed. Therefore, the block 7 may also be filtered. Therefore, in the case, the block 2 may be filtered by using the thread #1, and the block 7 may be filtered by using the thread #2, thereby implementing parallel filtering on the block 2 and the block 7.

Therefore, to complete filtering on the 24 blocks in FIG. 4, in a conventional filtering manner, 24 filtering operations need to be performed based on a time sequence, and correspond to 24 filtering time units. In a multi-threaded manner in the embodiment, some blocks may be filtered at the same time. Therefore, the time required for filtering the 24 blocks is less than the 24 filtering time units. Therefore, in the technical solution of the embodiment, filtering efficiency can be improved, and the time required for filtering can be reduced.

Compared with a single-threaded block-by-block filtering manner, the embodiment uses several threads, so that parallel filtering operations can be performed on different blocks by using two or more threads on the premise that a filtering rule is met, thereby improving efficiency.

In an optional embodiment, the several rows include a first row and one or more subsequent rows following the first row. The performing parallel filtering operations on at least two of the plurality of blocks in step S302 may include:
performing the following filtering operation on the first row: sequentially filtering each block in the first row from left to right; and
performing the following filtering operation on the one or more subsequent rows: sequentially filtering each block in a target row from left to right, wherein a filtering progress of the target row lags behind a filtering progress of a previous row of the target row by a filtering time of two blocks, and the target row is any one of the one or more subsequent rows.

The following provides descriptions by using an example with reference to FIG. 4.

In the example, the first row to the fourth row respectively correspond to different threads.

If the block 0 to the block 5 are the first row, filtering on the block 0 to the block 5 is performed from left to right without being constrained by other conditions. Each of the second row to fourth row is constrained by a filtering time of a previous row thereof. As shown in FIG. 5, a number in a quadrilateral block represents a serial number of the block, and a number in a circle represents a filtering operation order of the block. A filtering sequence is as follows:
a first filtering operation: the block 0;
a second filtering operation: the block 1;
a third filtering operation (parallel): the block 2 and the block 6;
a fourth filtering operation (parallel): a block 3 and the block 7;
a fifth filtering operation (parallel): a block 4, a block 8, and the block 12;
a sixth filtering operation (parallel): the block 5, a block 9, and a block 13;
a seventh filtering operation (parallel): a block 10, a block 14, and the block 18;
an eighth filtering operation (parallel): the block 11, a block 15, and a block 19;
a ninth filtering operation (parallel): a block 16 and a block 20;
a tenth filtering operation (parallel): the block 17 and a block 21;
an eleventh filtering operation: a block 22; and
a twelfth filtering operation: the block 23.

Based on the procedure in the embodiment, a parallel filtering manner is used in the third to tenth filtering operations. For example, in the third filtering operation, filtering may be performed on the block 2 by using the thread #1 corresponding to the first row, and filtering may be performed on the block 6 by using the thread #2 corresponding to the second row. Because different threads are used for the block 2 and the block 6, the block 2 and the block 6 may be filtered in parallel.

Therefore, to complete filtering on the 24 blocks in FIG. 4, in the conventional filtering manner, 24 filtering operations need to be performed based on a time sequence, and correspond to 24 filtering time units. In the technical solution of the embodiment, only 12 filtering operations (12 filtering time units) are required, so that filtering efficiency is improved, and the time required for filtering is reduced.

In an optional embodiment, the several rows include an m^{th} row and one or more subsequent rows following the m^{th} row, and m is an integer greater than or equal to 2. The performing parallel filtering operations on at least two of the plurality of blocks in step S302 may include:
sequentially filtering each block in a target row from left to right by using a thread allocated to the target row, wherein
a filtering progress of the target row lags behind a filtering progress of a previous row of the target row by a filtering time of two blocks, and the target row is the m^{th} row or any one of the one or more subsequent rows.

If the block 0 to the block5 are not the first row, filtering on the block 0 to the block5 is performed from left to right and is constrained by a previous row thereof. It can be learned that one or more new threads may be added to a decoding process as required to further improve efficiency.

In an optional embodiment, the target row corresponds to an n^{th} row, and n is an integer greater than or equal to 2; and correspondingly, the performing parallel filtering operations on at least two of the plurality of blocks in step S302 may include: (1) recording a quantity of filtered blocks in each row, wherein the quantity of filtered blocks indicates a quantity of currently filtered blocks; (2) filtering a currently unfiltered block in the n^{th} row when a quantity of filtered blocks in an (n−1)^{th} row is greater than a maximum preset value, wherein the maximum preset value is a total quantity of blocks in the (n−1)^{th} row; and (3) filtering a corresponding block in the n^{th} row when the quantity of filtered blocks is greater than 2 and is less than or equal to the maximum preset value, wherein a location of the corresponding block in the n^{th} row is the quantity of filtered blocks minus 2. In the foregoing recording and setting manners, each block may be controlled to be filtered at a specified progress, to ensure that each block does not fail to meet a filtering rule in AV1 due to premature filtering, and is not filtered with a delay.

In an optional embodiment, the method further includes:
when the quantity of filtered blocks in the (n−1)^{th} row is greater than the maximum preset value, configuring a thread for the (n−1)^{th} row to perform a filtering operation on an (n+N−1)^{th} row, wherein N is a positive integer, and is used to indicate a total quantity of the several threads.

If a quantity of rows formed by the plurality of blocks exceeds a preset quantity: in a first manner, a preset quantity of threads is configured, and each thread is correspondingly responsible for filtering of one row. In the first manner, a relatively large quantity of threads needs to be enabled, and a relatively large quantity of computer resources need to be occupied. In a second manner, several threads are set (a quantity of threads is less than the preset quantity). In the second manner, the thread is required to dynamically switch to processing of different rows. Taking the thread #1 as an example, when filtering of the block 0 to the block 5 is completed, the thread #1 needs to switch to be responsible for the 1^{st} row (from top to bottom) to which no thread is currently allocated and on which filtering does not start to be performed, so that a quantity of threads can be reduced.

For easier understanding of the application, the following provides an application example.

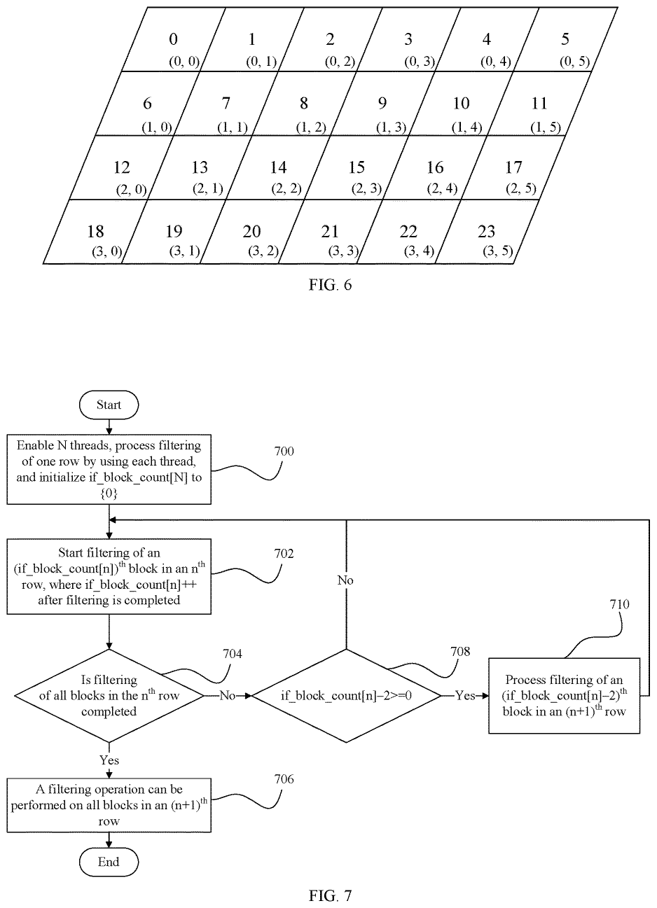

As shown in FIG. 6, a number in the middle of a quadrilateral block represents a serial number of the block, and a number in parentheses represents coordinates (y, x) of the block.

F(y, x)=2y+x+1. A filtering order of each block may be calculated by using the foregoing formula, and 1 is used as an initial value of the filtering order.

For example, for a block of coordinates (2, 0), a filtering order is 2*0+0+1=5. It can be learned that in the processing manner of the embodiment, an earliest processing sequence of the coordinates (2, 0) may be 5, and is earlier than the original processing sequence 12.

A total of 12 filtering operations are required for the foregoing partition to complete filtering, and an acceleration of 50% is achieved compared with the original 24 operations. For a common case, a total of 2y+x+1 operations are required for parallel filtering, and (x+1)*(y+1) operations are required for row-based filtering, thereby improving efficiency of (1−(2y+x+1)/((x+1)*(y+1)))*100%.

As shown in FIG. 7, a specific procedure operation may be as follows:

Step S700: Enable N threads, declare an array if_block_count[N] to record a quantity of currently filtered blocks, and initialize the array to 0. It should be noted that a quantity of threads may be set as required.

Step S702: Process a filtering operation on blocks in one row by using each thread, wherein each time processing of a block is completed, a corresponding quantity if_block_count increases by one, to be specific, assuming that filtering processing of an (if_block_count[n])^{th} block in an n^{th} row starts to be performed by using an n^{th} thread, if filtering processing of the (if_block_count[n])^{th} block is completed, then if_block_count[n]++.

Step S704: Determine whether filtering of all blocks in the n^{th} row is completed.

If yes, step S706 is entered. Otherwise, step S708 is entered.

Step S706: Determine that all blocks in an (n+1)^{th} row can be filtered without being limited by if_block_count[N]−2.

Step S708: Determine whether a quantity if_block_count[n] of blocks on which filtering is completed in the n^{th} row is greater than or equal to 2.

If yes, step S710 is entered. Otherwise, step S702 is entered.

Step S710: Process filtering of an (if_block_count[N]−2) th block in the (n+1)^{th} row. Step S702 is entered.

In AV1, the filtering operation involves a large quantity of pixel-level calculations, and consumes a large amount of time. In a multi-threaded filtering manner, encoding can be accelerated in live and on-demand streaming. Therefore, the filtering solution is of great practical value.

### Embodiment 2

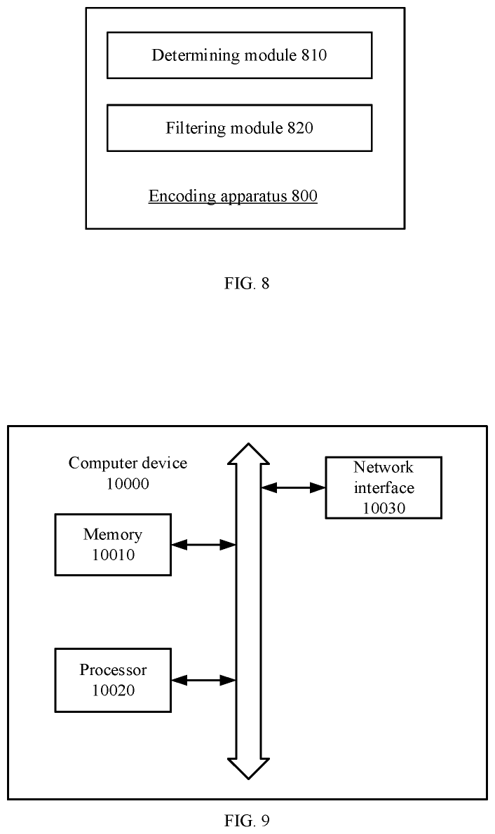

FIG. 8 schematically shows a block diagram of a filtering apparatus for AV1 according to Embodiment 2 of the application. The filtering apparatus for AV1 may be divided into one or more program module. The one or more program modules are stored in a storage medium and executed by one or more processors, to complete the embodiments of the application. The program module in the embodiment of the application is a series of computer-readable instruction segments that can complete a specific function. The following specifically describes a function of each program module in the embodiment. As shown in FIG. 8, the filtering apparatus 800 for AV1 may include a determining module 810 and a filtering module 820.

The determining module 810 is configured to determine a to-be-filtered partition, wherein the to-be-filtered partition includes a plurality of blocks, and the plurality of blocks form a plurality of rows; and
the filtering module 820 is configured to perform parallel filtering operations on at least two of the plurality of blocks by using several threads, wherein the several threads are responsible for filtering operations on several rows in a one-to-one correspondence, the several rows include at least two consecutive rows in the plurality of rows, and each block in the at least two blocks is respectively located in a different row.

In an optional embodiment, the several rows include a first row and one or more subsequent rows following the first row; and the filtering module 820 is further configured to:
perform the following filtering operation on the first row: sequentially filtering each block in the first row from left to right; and
perform the following filtering operation on the one or more subsequent rows: sequentially filtering each block in a target row from left to right, wherein a filtering progress of the target row lags behind a filtering progress of a previous row of the target row by a filtering time of two blocks, and the target row is any one of the one or more subsequent rows.

In an optional embodiment, the several rows include an m^{th} row and one or more subsequent rows following the m^{th} row, and m is an integer greater than or equal to 2; and the filtering module 820 is further configured to:
sequentially filter each block in a target row from left to right by using a thread allocated to the target row, wherein
a filtering progress of the target row lags behind a filtering progress of a previous row of the target row by a filtering time of two blocks, and the target row is the m^{th} row or any one of the one or more subsequent rows.

In an optional embodiment, the filtering module 820 is further configured to:
record a quantity of filtered blocks in each row, wherein the quantity of filtered blocks indicates a quantity of currently filtered blocks;
filter a currently unfiltered block in an n^{th} row when a quantity of filtered blocks in an (n−1)^{th} row is greater than a maximum preset value, wherein the maximum preset value is a total quantity of blocks in the (n−1)^{th} row, and n is an integer greater than or equal to 2; and
filter a corresponding block in the n^{th} row when the quantity of filtered blocks is greater than 2 and is less than or equal to the maximum preset value, wherein a location of the corresponding block in the n^{th} row is the quantity of filtered blocks minus 2.

In an optional embodiment, the encoding apparatus further includes a configuration module (not marked), configured to:
configure a thread for the (n−1)^{th} row to perform a filtering operation on an (n+N−1)^{th} row when the quantity of filtered blocks in the (n−1)^{th} row is greater than the maximum preset value, wherein N is a positive integer, and is used to indicate a total quantity of the several threads.

### Embodiment 3

FIG. 9 schematically shows a schematic diagram of a hardware architecture of a computer device 10000 suitable for implementing a filtering method for AV1 according to Embodiment 3 of the application. The computer device 10000 is a device that can automatically calculate a value and/or process information based on an instruction that is set or stored in advance. For example, the computer device 10000 may be a smartphone, a tablet computer, a PC, or a virtual reality device, etc. As shown in FIG. 9, the computer device 10000 at least includes but is not limited to a memory 10010, a processor 10020, and a network interface 10030 that can be communicatively connected to each other through a system bus.

The memory 10010 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 10010 may be an internal storage module of the computer device 10000, for example, a hard disk or an internal memory of the computer device 10000. In some other embodiments, the memory 10010 may alternatively be an external storage device of the computer device 10000, for example, a removable hard disk, a smart media card (SMC), a secure digital (SD) card, or a flash card that is disposed on the computer device 10000. Certainly, the memory 10010 may alternatively include both an internal storage module of the computer device 10000 and an external storage device of the computer device 10000. In the embodiment, the memory 10010 is usually configured to store an operating system and various types of application software that are installed on the computer device 10000, for example, program code of the filtering method for AV1. In addition, the memory 10010 may be further configured to temporarily store various types of data that have been output or are to be output.

The processor 10020 may be a central processing unit (CPU), a controller, a microcontroller, a microprocessor, or another data processing chip in some embodiments. The processor 10020 is usually configured to control an overall operation of the computer device 10000, for example, perform control and processing related to data exchange or communication performed by the computer device 10000. In the embodiment, the processor 10020 is configured to run program code stored in the memory 10010 or process data.

The network interface 10030 may include a wireless network interface or a wired network interface, and the network interface 10030 is usually configured to establish a communication link between the computer device 10000 and another computer device. For example, the network interface 10030 is configured to: connect the computer device 10000 and an external user terminal through a network, and establish a data transmission channel, a communication link, and the like between the computer device 10000 and the external user terminal. The network may be a wireless or wired network, for example, an Intranet, the Internet, a global system for mobile communications (GSM), a wideband code division multiple access (WCDMA), a 4G network, a 5G network, Bluetooth, or Wi-Fi.

It should be noted that FIG. 9 shows only a computer device with the components 10010 to 10030. However, it should be understood that implementation of all the shown components is not required, and more or fewer components may alternatively be implemented.

In the embodiment, the filtering method for AV1 stored in the memory 10010 may be further divided into one or more program modules to be executed by one or more processors (the processor 10020 in the embodiment), so as to complete the embodiments of the application.

### Embodiment 4

The application further provides a computer-readable storage medium, storing computer-readable instructions, wherein the computer-readable instructions are capable of being executed by at least one processor to enable the at least one processor to perform the following steps:
determining a to-be-filtered partition, wherein the to-be-filtered partition includes a plurality of blocks, and the plurality of blocks form a plurality of rows; and
performing parallel filtering operations on at least two of the plurality of blocks by using several threads, wherein the several threads are responsible for filtering operations on several rows in a one-to-one correspondence, the several rows include at least two consecutive rows in the plurality of rows, and each block in the at least two blocks are respectively located in a different row.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may alternatively be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is usually configured to store an operating system and various types of application software that are installed on the computer device, for example, program code of the filtering method for AV1 in the embodiments. In addition, the computer-readable storage medium may be further configured to temporarily store various types of data that have been output or are to be output.

Clearly, a person skilled in the art should understand that the foregoing modules or steps in the embodiments of the application may be implemented by using a general computing apparatus. The modules or steps may be integrated into a single computing apparatus or distributed in a network including a plurality of computing apparatuses. Optionally, the modules or steps may be implemented by using program code that can be executed by the computing apparatus. Therefore, the modules or steps may be stored in a storage apparatus for execution by the computing apparatus. In addition, in some cases, the shown or described steps may be performed in a sequence different from the sequence herein. Alternatively, the modules or steps may be separately made into integrated circuit modules, or a plurality of modules or steps in the module or steps may be made into a single integrated circuit module for implementation. In this way, a combination of any specific hardware and software is not limited in the embodiments of the application.

It should be noted that the foregoing descriptions are merely preferred embodiments of the application, and are not intended to limit the patent protection scope of the application. Any equivalent structure or equivalent procedure change made based on the content of the specification and the accompanying drawings of the application is directly or indirectly applied to other related technical fields, and shall fall within the patent protection scope of the application.

1. A filtering method for AV1, comprising:
determining a to-be-filtered partition, wherein the to-be-filtered partition comprises a plurality of blocks, and the plurality of blocks form a plurality of rows; and
performing parallel filtering operations on at least two of the plurality of blocks by using several threads, wherein the several threads are responsible for filtering operations on several rows in a one-to-one correspondence, the several rows comprise at least two consecutive rows in the plurality of rows, and each block in the at least two blocks is respectively located in a different row.

2. The method according to claim 1, wherein the several rows comprise a first row and one or more subsequent rows following the first row; and the performing parallel filtering operations on at least two of the plurality of blocks comprises:
performing the following filtering operation on the first row: sequentially filtering each block in the first row from left to right; and
performing the following filtering operation on the one or more subsequent rows: sequentially filtering each block in a target row from left to right, wherein a filtering progress of the target row lags behind a filtering progress of a previous row of the target row by a filtering time of two blocks, and the target row is any one of the one or more subsequent rows.

3. The method according to claim 1, wherein the several rows comprise an m^{th} row and one or more subsequent rows following the m^{th} row, and m is an integer greater than or equal to 2; and the performing parallel filtering operations on at least two of the plurality of blocks comprises:
sequentially filtering each block in a target row from left to right by using a thread allocated to the target row, wherein
a filtering progress of the target row lags behind a filtering progress of a previous row of the target row by a filtering time of two blocks, and the target row is the m^{th} row or any one of the one or more subsequent rows.

4. The method according to claim 2, wherein the target row corresponds to an n^{th} row, and n is an integer greater than or equal to 2; and the performing parallel filtering operations on at least two of the plurality of blocks comprises:
recording a quantity of filtered blocks in each row, wherein the quantity of filtered blocks indicates a quantity of currently filtered blocks;
filtering a currently unfiltered block in the n^{th} row when a quantity of filtered blocks in an (n−1)^{th} row is greater than a maximum preset value, wherein the maximum preset value is a total quantity of blocks in the (n−1)^{th} row; and
filtering a corresponding block in the n^{th} row when the quantity of filtered blocks is greater than 2 and is less than or equal to the maximum preset value, wherein a location of the corresponding block in the n^{th} row is the quantity of filtered blocks minus 2.

5. The method according to claim 4, further comprising:
configuring a thread for the (n−1)^{th} row to perform a filtering operation on an (n+N−1)^{th} row when the quantity of filtered blocks in the (n−1)^{th} row is greater than the maximum preset value, wherein N is a positive integer, and is used to indicate a total quantity of the several threads.

6. (canceled)

7. (canceled)

8. (canceled)

9. (canceled)

10. (canceled)

11. A computer device, comprising a memory, a processor, and computer-readable instructions that are stored in the memory and that are capable of running on the processor, wherein when executing the computer-readable instructions, the processor is configured to implement the following steps:
determining a to-be-filtered partition, wherein the to-be-filtered partition comprises a plurality of blocks, and the plurality of blocks form a plurality of rows; and
performing parallel filtering operations on at least two of the plurality of blocks by using several threads, wherein the several threads are responsible for filtering operations on several rows in a one-to-one correspondence, the several rows comprise at least two consecutive rows in the plurality of rows, and each block in the at least two blocks are respectively located in a different row.

12. The computer device according to claim 11, wherein the several rows comprise a first row and one or more subsequent rows following the first row; and the performing parallel filtering operations on at least two of the plurality of blocks comprises:
performing the following filtering operation on the first row: sequentially filtering each block in the first row from left to right; and
performing the following filtering operation on the one or more subsequent rows: sequentially filtering each block in a target row from left to right, wherein a filtering progress of the target row lags behind a filtering progress of a previous row of the target row by a filtering time of two blocks, and the target row is any one of the one or more subsequent rows.

13. The computer device according to claim 11, wherein the several rows comprise an m^{th} row and one or more subsequent rows following the m^{th} row, and m is an integer greater than or equal to 2; and the performing parallel filtering operations on at least two of the plurality of blocks comprises:
sequentially filtering each block in a target row from left to right by using a thread allocated to the target row, wherein
a filtering progress of the target row lags behind a filtering progress of a previous row of the target row by a filtering time of two blocks, and the target row is the m^{th} row or any one of the one or more subsequent rows.

14. The computer device according to claim 12, wherein the target row corresponds to an n^{th} row, and n is an integer greater than or equal to 2; and the performing parallel filtering operations on at least two of the plurality of blocks comprises:
recording a quantity of filtered blocks in each row, wherein the quantity of filtered blocks indicates a quantity of currently filtered blocks;
filtering a currently unfiltered block in the n^{th} row when a quantity of filtered blocks in an (n−1)^{th} row is greater than a maximum preset value, wherein the maximum preset value is a total quantity of blocks in the (n−1)^{th} row; and
filtering a corresponding block in the n^{th} row when the quantity of filtered blocks is greater than 2 and is less than or equal to the maximum preset value, wherein a location of the corresponding block in the n^{th} row is the quantity of filtered blocks minus 2.

15. The computer device according to claim 14, wherein when executing the computer-readable instructions, the processor is further configured to implement the following step:
configuring a thread for the (n−1)^{th} row to perform a filtering operation on an (n+N−1)^{th} row when the quantity of filtered blocks in the (n−1)^{th} row is greater than the maximum preset value, wherein N is a positive integer, and is used to indicate a total quantity of the several threads.

16. A non-transitory computer-readable storage medium, storing computer-readable instructions, wherein the computer-readable instructions are capable of being executed by at least one processor to enable the at least one processor to perform the following steps:
determining a to-be-filtered partition, wherein the to-be-filtered partition comprises a plurality of blocks, and the plurality of blocks form a plurality of rows; and
performing parallel filtering operations on at least two of the plurality of blocks by using several threads, wherein the several threads are responsible for filtering operations on several rows in a one-to-one correspondence, the several rows comprise at least two consecutive rows in the plurality of rows, and each block in the at least two blocks is respectively located in a different row.

17. The non-transitory computer-readable storage medium according to claim 16, wherein the several rows comprise a first row and one or more subsequent rows following the first row; and the performing parallel filtering operations on at least two of the plurality of blocks comprises:
performing the following filtering operation on the first row: sequentially filtering each block in the first row from left to right; and
performing the following filtering operation on the one or more subsequent rows: sequentially filtering each block in a target row from left to right, wherein a filtering progress of the target row lags behind a filtering progress of a previous row of the target row by a filtering time of two blocks, and the target row is any one of the one or more subsequent rows.

18. The non-transitory computer-readable storage medium according to claim 16, wherein the several rows comprise an m^{th} row and one or more subsequent rows following the m^{th} row, and m is an integer greater than or equal to 2; and the performing parallel filtering operations on at least two of the plurality of blocks comprises:
sequentially filtering each block in a target row from left to right by using a thread allocated to the target row, wherein
a filtering progress of the target row lags behind a filtering progress of a previous row of the target row by a filtering time of two blocks, and the target row is the m^{th} row or any one of the one or more subsequent rows.

19. The non-transitory computer-readable storage medium according to claim 17, wherein the target row corresponds to an n^{th} row, and n is an integer greater than or equal to 2; and the performing parallel filtering operations on at least two of the plurality of blocks comprises:
recording a quantity of filtered blocks in each row, wherein the quantity of filtered blocks indicates a quantity of currently filtered blocks;
filtering a currently unfiltered block in the n^{th} row when a quantity of filtered blocks in an (n−1)^{th} row is greater than a maximum preset value, wherein the maximum preset value is a total quantity of blocks in the (n−1)^{th} row; and
filtering a corresponding block in the n^{th} row when the quantity of filtered blocks is greater than 2 and is less than or equal to the maximum preset value, wherein a location of the corresponding block in the n^{th} row is the quantity of filtered blocks minus 2.

20. The non-transitory computer-readable storage medium according to claim 19, wherein the at least one processor further performs the following step:
configuring a thread for the (n−1)^{th} row to perform a filtering operation on an (n+N−1)^{th} row when the quantity of filtered blocks in the (n−1)^{th} row is greater than the maximum preset value, wherein N is a positive integer, and is used to indicate a total quantity of the several threads.
